(19) United States
(12) Patent Application Publication
(10) Pub. No.: US 2026/0011865 A1
(43) Pub. Date: Jan. 8, 2026

(54) BATTERY PACK FOR AN ELECTRIC VEHICLE

(71) Applicant: BOMBARDIER RECREATIONAL PRODUCTS INC., Valcourt (CA)

(72) Inventors: Thomas DRIANT, Saint-Francois-Xavier-de-Brompton (CA); Alain LAVOIE, Drummondville (CA); Nicolas LABBE, St-Luce (CA)

(21) Appl. No.: 19/259,977

(22) Filed: Jul. 3, 2025

Related U.S. Application Data
(60) Provisional application No. 63/667,948, filed on Jul. 5, 2024.

(51) Int. Cl. H01M 50/383; B60L 50/64; H01M 50/213; H01M 50/249; H01M 50/258; H01M 50/291; H01M 50/30; H01M 50/342

(52) U.S. Cl. CPC H01M 50/383; B60L 50/64; H01M 50/213; H01M 50/249; H01M 50/258; H01M 50/291; H01M 50/3425; H01M 50/394; H01M 2220/20

(57) ABSTRACT

A battery pack for an electric vehicle. The battery pack includes a housing; battery cells disposed inside the housing; and a barrier disposed in the housing. The barrier includes at least one barrier plate facing the battery cells, the at least one barrier plate having a plurality of apertures defined therein, the at least one barrier plate including a plurality of louvers, each louver of the plurality of louvers being formed around a portion of a corresponding aperture of the plurality of apertures, each battery cell of the plurality of battery cells having a first end portion and a second end portion, the first end portion of each battery cell of the plurality of battery cells being arranged closer to the barrier than the second end portion of each battery cell.

### CROSS-REFERENCE

The present application claims priority to U.S. Provisional Patent Application No. 63/667,948, entitled “Battery Pack for an Electric Vehicle,” filed Jul. 5, 2024, the entirety of which is incorporated by reference herein.

### FIELD OF TECHNOLOGY

The present technology relates to battery packs for electric vehicles.

### BACKGROUND

As the move toward electrification of vehicles progresses, interest in electric versions of different vehicles, including recreational vehicles such as snowmobiles and all-terrain vehicles (ATVs), with improved range and performance continues. In some cases, improving range and performance is solved by inclusion of a relatively large battery assembly, such as a large traction battery.

When incorporating a large traction battery into a vehicle, however, difficulty could be encountered in fitting the battery into the frame and/or around other necessary vehicle components. This can especially be an issue for smaller recreational vehicles, where some components such as steering columns and drive shafts occupy relatively large areas within the vehicle body. By condensing battery pack arrangements with efficient packing, battery packs may take up less volume within the vehicle.

As is known in the industry of rechargeable electrical energy storage systems (REESS), one or more battery cells may vent hot gases during an exothermic reaction during operation of the battery pack. In arrangements with close packed battery cells, efficient evacuation of expelled hot gases is especially important.

There is therefore a desire for battery pack arrangements for electric vehicles addressing at least some of the above-described disadvantages.

### SUMMARY

It is an object of the present technology to ameliorate at least some of the inconveniences present in the prior art.

According to one aspect of the present technology, there is provided a battery pack for an electric vehicle. The battery pack includes one or more barrier structures to separate different groups of battery cells for impeding the propagation of thermal events between different battery cell sections of the battery pack. Specifically, the barrier includes one or more barrier plates disposed between the battery cell groups (in this case, modules). The barrier plate includes louvers formed around apertures in the plate. The apertures are aligned with the battery cells ends to receive ejecta therethrough. The louvers direct ejecta from the battery cells, if a venting event occurs, away from a neighboring module and toward the battery pack housing. In some embodiments, the housing includes openings or valves to permit the housing to vent hot gases/ejecta out of the housing as well.

According to one aspect of the present technology, there is provided a battery pack for an electric vehicle. The battery pack includes a housing; a first plurality of battery cells disposed inside the housing; a second plurality of battery cells disposed inside the housing; and a barrier disposed in the housing, the barrier being disposed between the first plurality of battery cells and the second plurality of battery cells. The barrier includes a first barrier plate facing the first plurality of battery cells, the first barrier plate having a first plurality of apertures defined therein, the first barrier plate including a first plurality of louvers, each louver of the first plurality of louvers being formed around a portion of a corresponding aperture of the first plurality of apertures; and a second barrier plate facing the second plurality of battery cells, the second barrier plate having a second plurality of apertures defined therein, the second barrier plate including a second plurality of louvers, each louver of the second plurality of louvers being formed around a portion of a corresponding aperture of the second plurality of apertures. Each battery cell of the first plurality of battery cells and the second plurality of battery cells has a first end portion and a second end portion, the first end portion of each battery cell of the first plurality of battery cells and the second plurality of battery cells being arranged closer to the barrier than the second end portion of each battery cell.

In some embodiments, the first plurality of louvers and the second plurality of louvers are configured and arranged to direct ejecta from at least one battery cell of the first plurality of battery cells and the second plurality of battery cells toward the housing.

In some embodiments, for each battery cell of the first plurality of battery cells and the second plurality of battery cells, the battery cell includes a battery casing extending from the first end portion to the second end portion; and a venting valve at least partially disposed in the battery casing, the venting valve being disposed in the first end portion.

In some embodiments, for each battery cell of the first plurality of battery cells and the second plurality of battery cells, the venting valve is arranged to vent gases toward the barrier.

In some embodiments, for each battery cell of the first plurality of battery cells and the second plurality of battery cells, the first end portion defines at least a positive terminal of the battery cell.

In some embodiments, for each battery cell of the first plurality of battery cells and the second plurality of battery cells, the first end portion is at least partially aligned with a corresponding louver of the first and second plurality of louvers.

In some embodiments, each louver of the first plurality of louvers defines a first opening between an edge of the louver and the first barrier plate, the first opening being fluidly connected with a corresponding aperture of the first plurality of apertures; and each louver of the second plurality of louvers defines a second opening between an edge of the louver and the second barrier plate, the second opening being fluidly connected with a corresponding aperture of the second plurality of apertures.

In some embodiments, a distance from the first barrier plate and a center of the edge of each louver of the first plurality of louvers is about 3 millimeters; and a distance from the second barrier plate and a center of the edge of each louver of the second plurality of louvers is about 3 millimeters.

In some embodiments, the first openings of the first plurality of louvers and the second openings of the second plurality of louvers face a same direction.

In some embodiments, the first barrier plate and the second barrier plate are separated by about 10 millimeters.

In some embodiments, the first barrier plate and the second barrier plate are formed from an inflammable material.

In some embodiments, the first barrier plate and the second barrier plate are formed from metal.

In some embodiments, the first plurality of louvers and the second plurality of louvers have a curved profile.

In some embodiments, the housing defines therein at least one vent fluidly connecting an interior of the housing with an exterior of the housing.

In some embodiments, the vent is arranged in fluid communication with the barrier.

In some embodiments, the first plurality of louvers and the second plurality of louvers open toward the vent.

In some embodiments, the first plurality of battery cells is supported in a first frame; and the second plurality of battery cells is supported in a second frame.

In some embodiments, the first barrier plate is connected to the first frame; and the second barrier plate is connected in the second frame.

In some embodiments, the first frame defines a first plurality of pockets, each battery cell of the first plurality of battery cells being received in a corresponding one of the first plurality of pockets; and the second frame defines a second plurality of pockets, each battery cell of the second plurality of battery cells being received in a corresponding one of the second plurality of pockets.

According to another aspect of the present technology, there is provided a battery pack for an electric vehicle. The battery pack includes a housing; at least one plurality of battery cells disposed inside the housing; and a barrier disposed in the housing. The barrier includes at least one barrier plate facing the at least one plurality of battery cells, the at least one barrier plate having a plurality of apertures defined therein, the at least one barrier plate including a plurality of louvers, each louver of the plurality of louvers being formed around a portion of a corresponding aperture of the plurality of apertures, each battery cell of the plurality of battery cells having a first end portion and a second end portion, the first end portion of each battery cell of the plurality of battery cells being arranged closer to the barrier than the second end portion of each battery cell.

In some embodiments, the plurality of louvers are configured and arranged to direct ejecta from at least one battery cell of the plurality of battery cells toward the housing.

In some embodiments, each battery cell includes a battery casing extending from the first end portion to the second end portion; and a venting valve at least partially disposed in the battery casing, the venting valve being disposed in the first end portion.

In some embodiments, for each battery cell of the plurality of battery cells, the venting valve is arranged to vent gases toward the barrier.

In some embodiments, for each battery cell of the plurality of battery cells, the first end portion defines at least a positive terminal of the battery cell.

In some embodiments, for each battery cell of the plurality of battery cells, the first end portion is at least partially aligned with a corresponding louver of the plurality of louvers.

In some embodiments, each louver of the plurality of louvers defines an opening between an edge of the louver and the at least one barrier plate, the opening being fluidly connected with a corresponding aperture of the plurality of apertures.

In some embodiments, a distance from the at least one barrier plate and a center of the edge of each louver of the plurality of louvers is about 3 millimeters.

In some embodiments, the at least one barrier plate is formed from an inflammable material.

In some embodiments, the at least one barrier plate is formed from metal.

In some embodiments, each louver of the plurality of louvers has a curved profile.

In some embodiments, the housing defines therein at least one vent fluidly connecting an interior of the housing with an exterior of the housing.

In some embodiments, the vent is arranged in fluid communication with the barrier.

In some embodiments, the plurality of louvers opens toward the vent.

For the purposes of the present application, terms related to spatial orientation such as forward, rearward, front, rear, upper, lower, left, and right, are assigned to a particular orientation of the battery pack. It should be understood that the battery pack could be installed in a different orientation, that is with the nominal “top side” not oriented in an upward direction, in different vehicles.

Embodiments of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of embodiments of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a top, side perspective view of a battery pack according to a non-limiting embodiment of the present technology;

FIG. 2 is another top, side perspective view of the battery pack of FIG. 1;

FIG. 3 is a partial, cross-sectional view of the battery pack of FIG. 1;

FIG. 4 is a schematic drawing of a battery cell of the battery pack of FIG. 1;

FIG. 5 is a perspective view of the battery pack of FIG. 1, with portions including a housing thereof having been removed;

FIG. 6 is a perspective view of a battery module of the battery pack of FIG. 1;

FIG. 7 is a perspective, exploded view of the battery module of FIG. 6;

FIG. 8 is a front side elevation of the battery module of FIG. 6;

FIG. 9 is a perspective view of a barrier plate of the battery pack of FIG. 1;

FIG. 10 is a close-up, partial, cross-sectional view of a barrier and modules of the battery pack of FIG. 1;

FIG. 11 is a close-up view of the barrier and modules of FIG. 10; and

FIG. 12 is a perspective view of the battery pack of FIG. 1, with the housing having been removed.

It should be noted that, unless otherwise explicitly specified herein, the drawings are not necessarily to scale.

### DETAILED DESCRIPTION

The present technology will be described herein with respect to a battery pack 100 for powering an electric vehicle. The battery pack 100 could be implemented in a variety of vehicle types, including but not limited to electric snowmobiles, electric all-terrain vehicles (ATVs), two-wheeled straddle-seat electric vehicles (e.g. electric motorcycles, electric scooters), three-wheeled electric vehicles (including three-wheeled straddle-seat vehicles), electric side-by-side vehicles (SSVs), and four-wheeled electric vehicles.

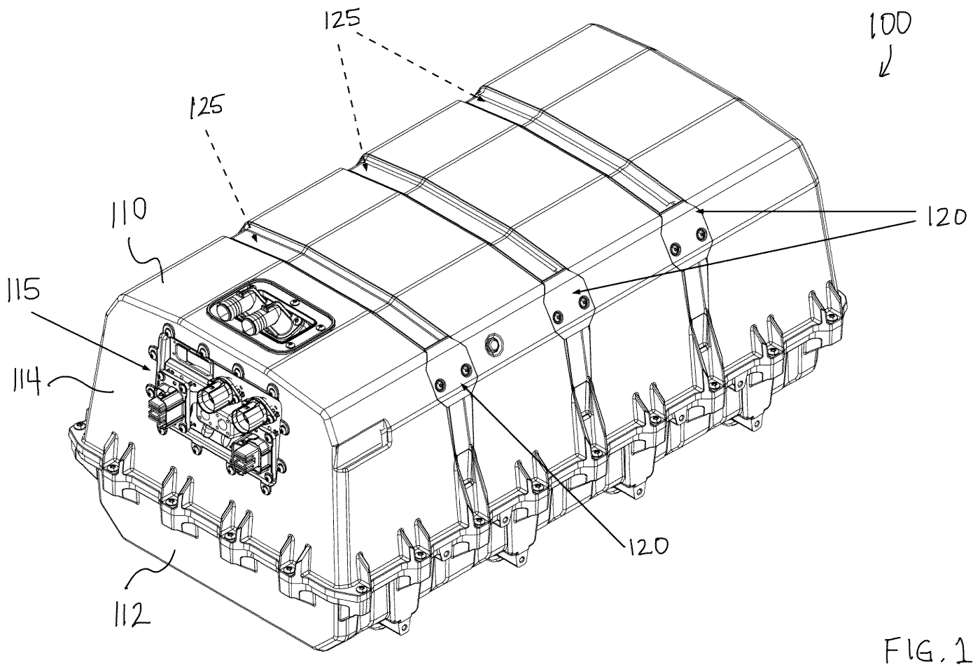

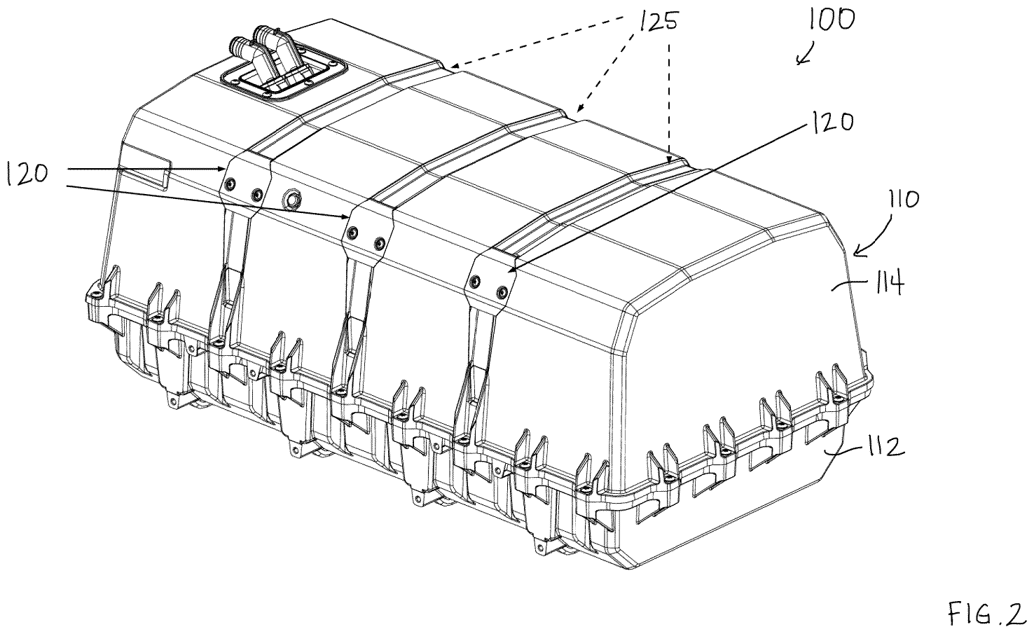

With reference to FIGS. 1 and 2, the battery pack 100 includes a battery housing 110. The battery housing 110 encloses different components of the battery pack 100. The housing 110 provides connections for connecting to other vehicle components (not shown), specifically via a connections panel 115 at one end of the housing 110. The connections panel 115 could connect to a variety of components of the vehicle, including but not limited to: a charger, an inverter, and a 12V battery.

In the illustrated embodiment, the battery housing 110 has a generally rectangular cuboid form, with three orthogonal axes generally defining the form. It is contemplated that the battery housing 110 could be differently shaped. In the present embodiment, the housing 110 is formed from aluminum, but could be formed from different materials, including but not limited to plastic or other metals.

The battery housing 110 includes a bottom side cover 112 and a top side cover 114 selectively fastened to the bottom side cover 112. It is contemplated that the covers 112, 114 could be connected together in different manners, including for example by tabs. It is also contemplated that the housing 110 could be formed by more than two portions in some embodiments.

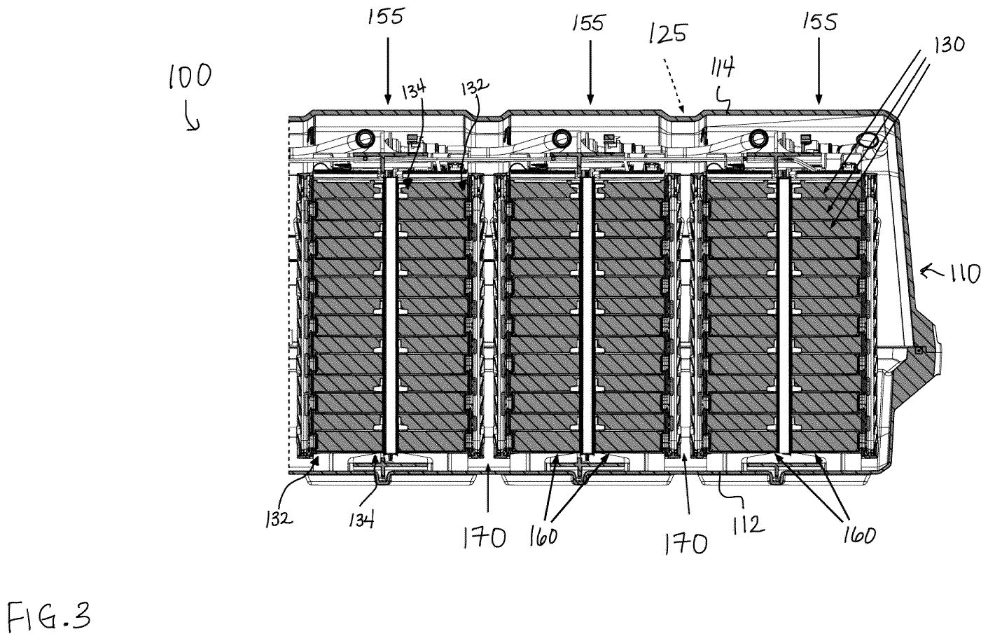

With reference to FIG. 3, the battery pack 100 includes a plurality of battery cells 130 disposed in the battery housing 110. In the present embodiment, the battery cells 130 are cylindrical battery cells 130. More specifically, in the present embodiment, the battery cells 130 are 3.5V cylindrical cells, such as LG™ M50L lithium-ion cells in 21700 format, but it is contemplated that different versions of cells could be used in some embodiments. For example, battery cells could vary in nominal energy capacity, usable energy capacity, discharge rate, cell chemistry, cell geometry and cell type.

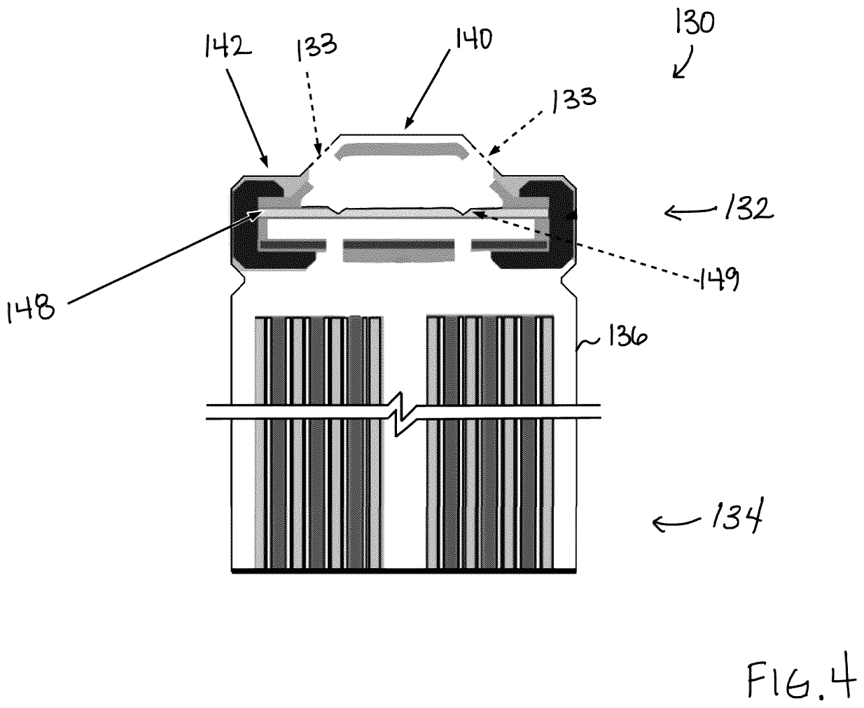

One of the battery cells 130 is illustrated schematically in FIG. 4. Each battery cell 130 has a first end portion 132 and a second end portion 134 opposite the first end portion 132. The first and second end portions 132, 134 are disposed at opposite ends of the cylindrical form from the battery cell 130. Each battery cell 130 includes a battery casing 136 extending from the first end portion 132 to the second end portion 134. The battery casing 136 surrounds and supports the internal components of the battery cell 130.

The first end portion 132 of each battery cell 130 defines and forms a positive terminal 140 connected to the battery casing 136. By the present embodiment, the first end portion 132 also defines and forms a negative terminal 142 of the battery cell 130. In some embodiments, another portion of the battery cell 130 may form or support the negative terminal of the battery cell 130.

The battery cell 130 further includes a venting valve 148 at least partially disposed in the battery casing 136. Specifically, in the illustrated embodiment, the venting valve 148 is a vent disk 148 disposed in the first end portion. Upon production of gases and/or heating of the components inside the battery casing 136, the vent disk 148 is designed to break, yield, or otherwise give way to heated gases to permit venting of the battery cell 130 to reduce the risk of an explosion. By the present embodiment, the vent disk 148 has one or more grooves 149 formed therein to create weak portions in disk 148 in the case of pressure build up. In some embodiments, a venting valve or disk could be formed and arranged to melt to permit venting. As can be seen in FIG. 4, the first end portion 132 is configured and arranged to vent heated gases, if heat and/or pressure build up were to occur, through the end portion 132. Between the positive terminal and the negative terminal, the first end portion 132 includes two openings 133 to permit hot gases and eject to escape when internal pressure and/or heating break through the weakened portions of the disk 148.

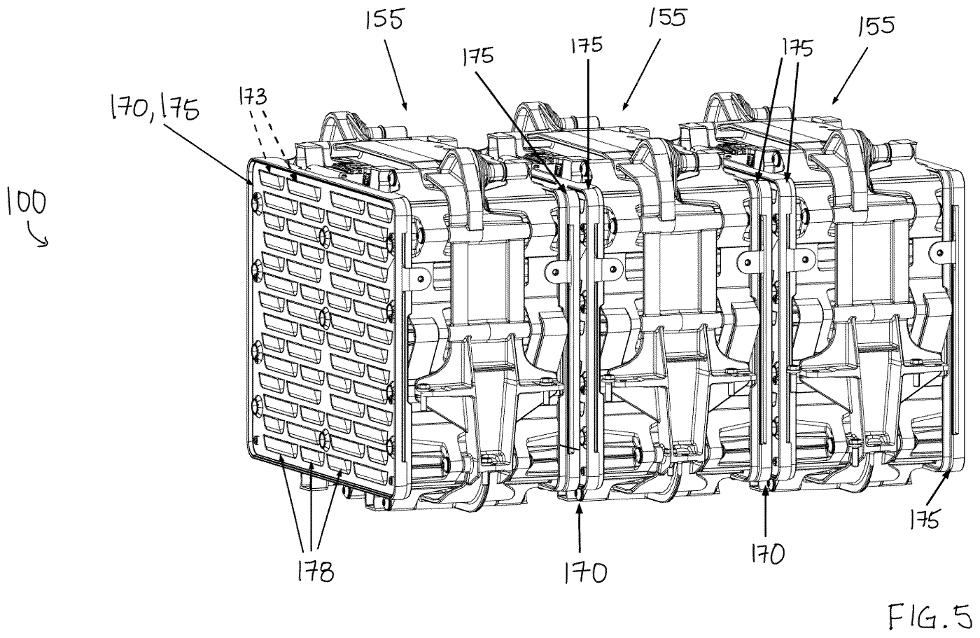

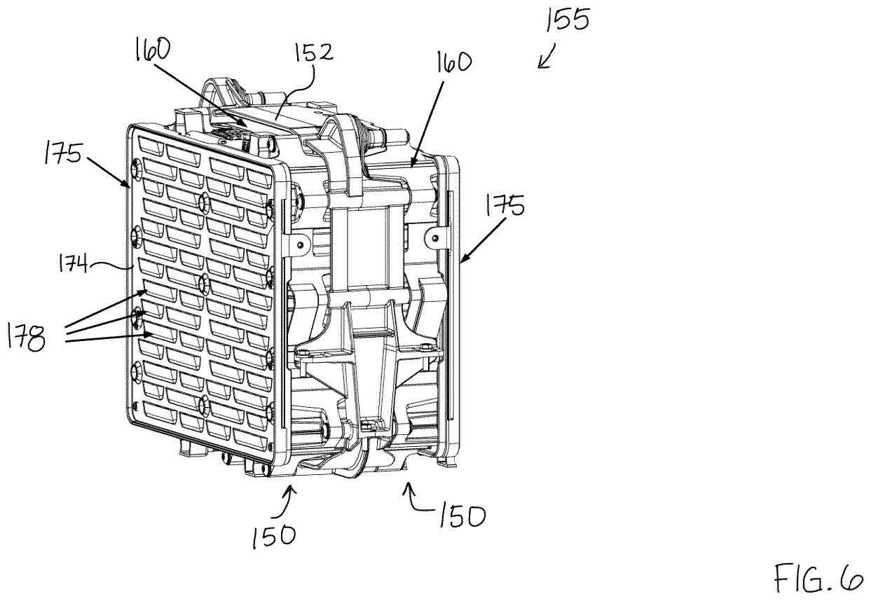

With additional reference to FIGS. 5 to 7, the battery cells 130 are arranged in a plurality of battery modules 150 disposed in the battery housing 110. In the illustrated embodiment, the battery pack 100 includes three battery module assemblies 155, each assembly 155 having two battery modules 150. It is contemplated that different embodiments of battery packs 100 could include more or fewer battery modules 150.

In the illustrated embodiment, each module assembly 155 supports 392 battery cells 130. It is contemplated that each battery assembly 155 could include more or fewer battery cells 130 or have more or fewer battery modules 130 generally. Depending on the number of battery cells 130 in each module 150 and/or the total number of modules 150 in a given embodiment, it is also contemplated that the total number of battery cells 130 in the battery pack 100 could vary.

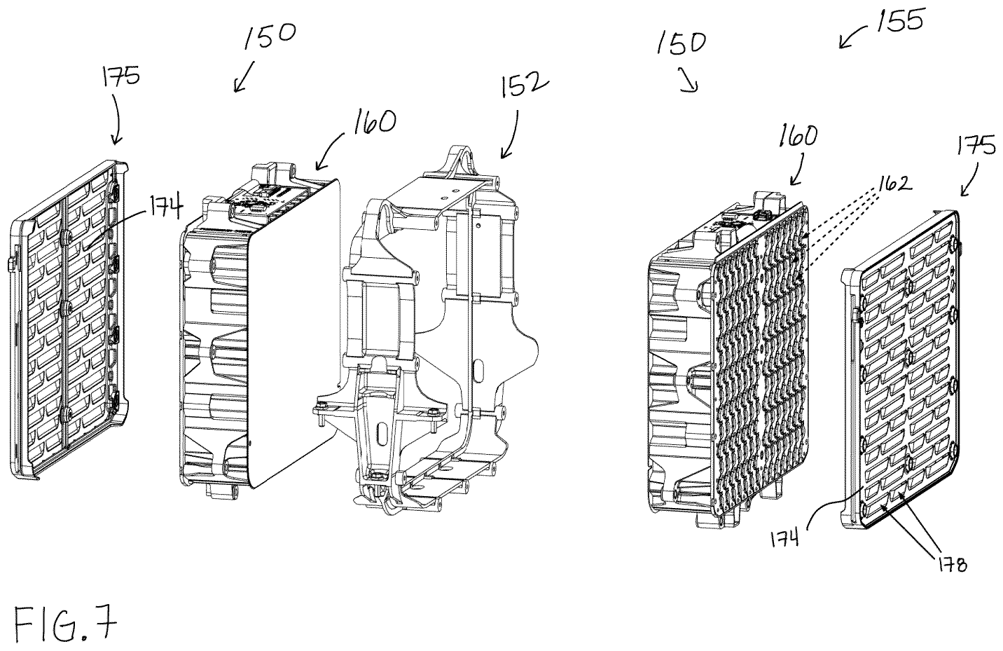

Each module 150 includes a battery frame 160, also referred to as a support matrix 160, for supporting the battery cells 130 (see FIGS. 3 and 7) as well as other components connected thereto. The two battery frames 160 are connected to a module assembly frame 152. The particular arrangement of the modules 150 and the module assemblies 155 could vary in different embodiments.

Each battery frame 160 is formed from a rigid, electrically isolating material, specifically a rigid plastic in the present embodiment. The battery frame 160 defines therein 196 generally cylindrical cavities 162, or pockets 162, for receiving the battery cells 130 in the battery frame 160. In the illustrated embodiment, the battery frame 160 is formed such that the 196 battery cells 130 disposed in each module 150 are arranged in fourteen parallel rows of fourteen cells 130. It is contemplated that the particular physical distribution of battery cells 130 in each module 150 or module assembly 155 could vary. For instance, in some embodiments, each module assembly 155 or one or more module assemblies 155 of a given battery pack could include only one frame 160 and/or module 150. In embodiments where different size formats of cylindrical cells are used, it is contemplated that the frame 160 could be sized and shaped to receive the different battery format therein.

As is highlighted in FIG. 3, the battery cells 130 are oriented in the corresponding battery frame 160 with the second end portions 154 disposed on an interior of the frame 160 and the first end portions 152 facing outward from the frame 160. As is noted above, venting structures of each battery cell 130 are arranged in the first end portion 132. The first end portions 132 are thus oriented facing out of its corresponding module 150. In the case of a venting event, ejecta from the battery cell 130 will thus be projected or emitted out of the module assembly 155, rather than into the other cells 130 comprising the other module 160, which is part of the same module assembly 155.

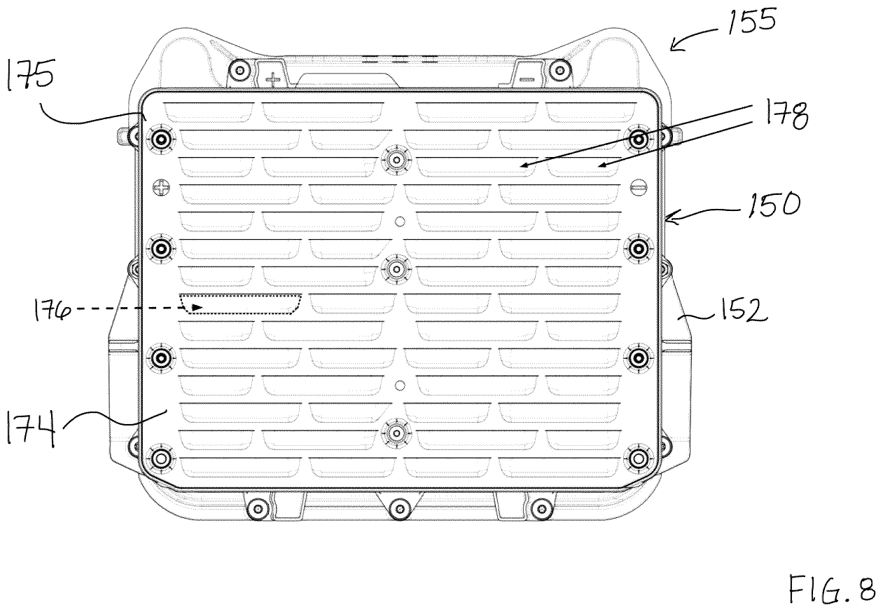

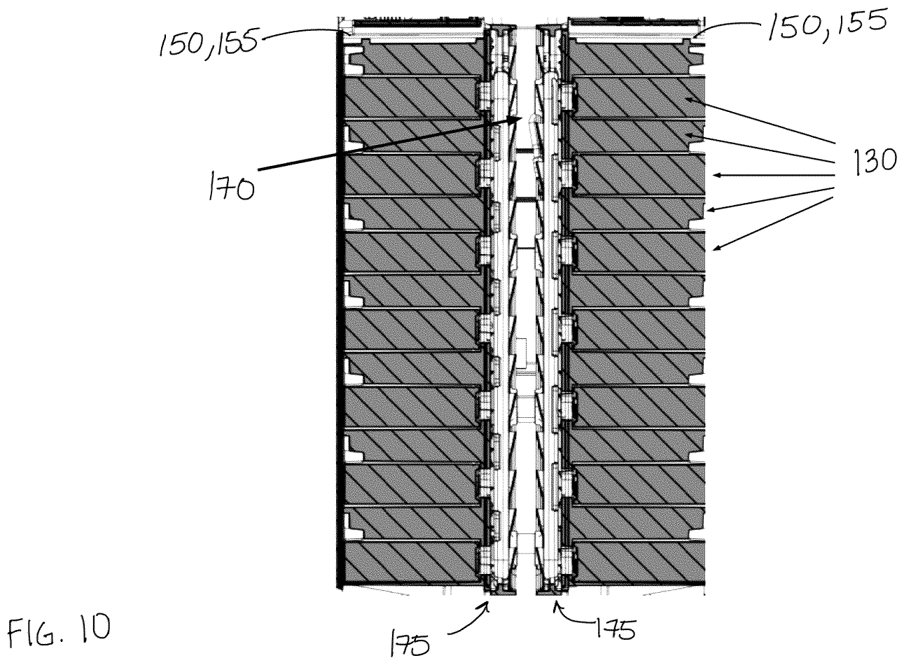

With additional reference to FIGS. 8 to 10, the battery pack 100 includes one or more barriers 170 disposed in the housing 110 to aid in directing hot gases and ejecta from the battery cells 130 away from other battery cells 130 or modules 150, and toward an exterior of the housing 110. The barrier 170 is disposed between the two sets of battery cells 130 to impede ejecta from one set from reaching the other. In the present arrangement, the barrier 170 is positioned between the first end of the battery cells 130 of one module 150 and the first end of the battery cells 130 of the adjacent module 150 of the adjacent battery module assembly 155.

In the illustrated embodiment, the barrier 170 includes one barrier plate 175 facing one set of battery cells 130 and another barrier plate 175 facing the set of battery cells 130 supported by the neighboring module 150. In some embodiments, for example on the end module 150 illustrated in FIG. 5, the barrier 170 is formed from a single barrier plate 175. The single barrier plate 175 can aid in impeding ejecta from a battery cell 130 from impacting the housing 110 and/or other components of the battery pack 100. It is also contemplated that a single barrier plate 175 could be disposed between two modules 150 in some embodiments.

In the present embodiment, the barrier plates 175 are connected to the corresponding battery frames 160. Each module 150 thus has a barrier plate 175 connected to each side thereof. While connecting the barrier plates 175 to modules 150 aids in simplifying fabrication of the battery pack 100, the barrier 170 could be connected to the module assembly frame 152, or otherwise differently installed between the modules 150.

As the barrier plates 175 are meant to aid in protecting from hot ejecta/gases, the barrier plates 175 are formed from an inflammable material. In the present embodiment, the barrier plates 175 are specifically formed from metal.

Each barrier plate 175 is formed by a plate body 174 with a plurality of apertures 176 defined therein. Each barrier plate 175 further has plurality of louvers 178 connected to the plate body 174. The louvers 178 are integrally formed with the plate body 174 of the illustrated embodiment, but it is contemplated that the louvers 178 could be differently connected thereto.

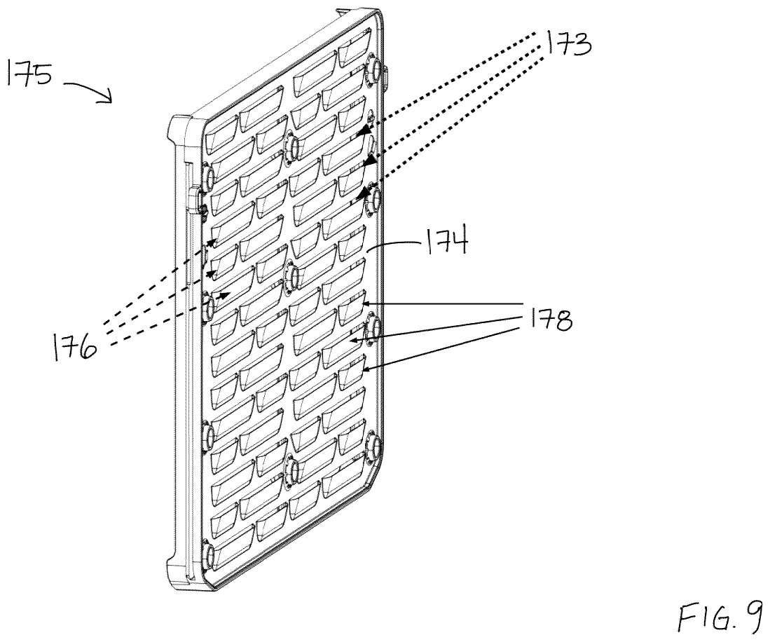

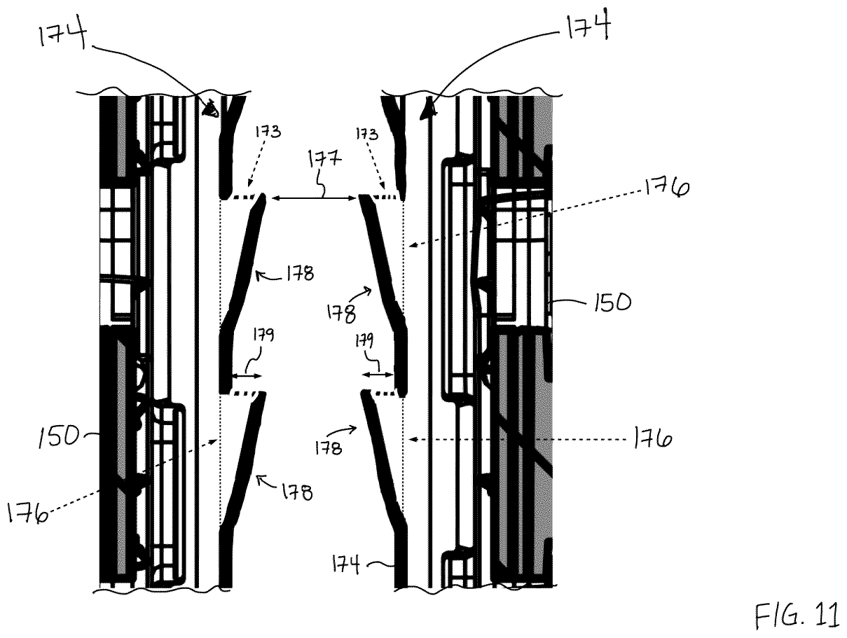

Each louver 178 is formed around a portion of a corresponding one of the apertures 176, see for instance FIGS. 9 and 11. By the illustrated embodiment, the louvers 178 have a partially curved profile, with a cross-sectional form generally curved as the louver 178 extends away from the aperture 176 and then extending generally linearly/diagonally away from the plate body 174. It is contemplated that the specific shape of the louvers 178 could vary in different embodiments.

To aid in more efficiently directing ejecta and/or hot gases from the battery cells 130 away from other battery cells 130 and/or modules 150, the first end portion 132 of each battery cell 130 is at least partially aligned with a corresponding aperture 176 and louver 178. With the first end portions 132 of the battery cells 130 being disposed closer to the barrier 170 than the second end portions 134 thereof, the venting valve 148 of each battery cell 130 is arranged to vent gases toward the barrier 170 in the case of a venting event. The louvers 178 of neighboring barrier plates 175 further face a same direction, directing the ejecta in a same direction. This further aids in avoiding ejecta from one barrier plate 175 from entering into the louvers 178 and aperture 176 of the facing barrier plate 175. Specifically, each louver 178 defines an opening 173 between an edge of the louver 178 and the plate body 174, the opening 173 being fluidly connected with the corresponding aperture 176.

With continued reference to FIG. 11, dimensions of the present non-limiting embodiment of the barrier 170 are illustrated in more detail. 10. Two neighboring barrier plates 175, corresponding to two neighboring modules 150, are spaced by a separation 177 by about 10 millimeters. On each barrier plate 175, a width 179 of the opening 173 of each louver 178 is defined from the plate body 174 and a center of the edge of each louver 178. In the present embodiment, the width 179 of the opening 173 is about 3 millimeters. The dimensions of the opening 173 could vary depending on a variety of factors, such as estimated gas pressure and rate of flow out of a cell.

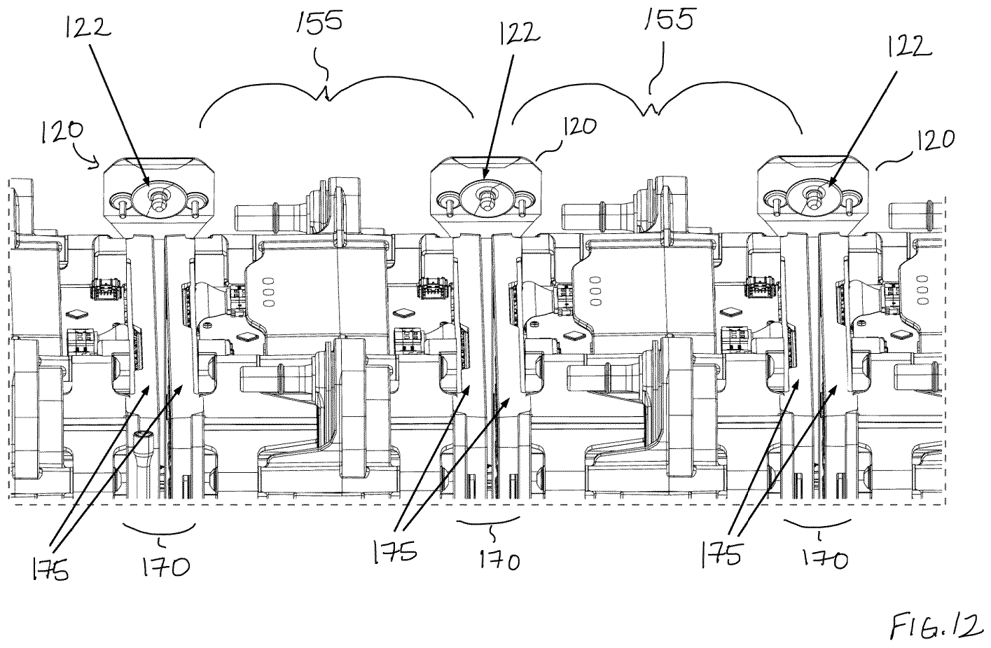

With reference to FIGS. 1 and 2, and additional reference to FIG. 12, the housing 110 is further configured and arranged to aid in moving ejecta from battery cells 130 away from other battery cells 130 or components of the battery pack 100. The battery pack 110 includes one or more vents 120 fluidly connecting an interior of the housing 110 with an exterior of the housing 110. The vents 120 in the present embodiment each include a valve 122, illustrated without the housing 110 in FIG. 12. The valves 122 are configured and arranged to permit hot gases/ejecta to pass from an interior of the housing 110 to an exterior thereof, while impeding entry of moisture and/or debris from an exterior of the housing 110 into the interior thereof. The vents 120 are arranged in fluid communication with the barriers 170. Specifically, as can be seen in FIGS. 3 and 12, each barrier 170 is generally aligned with a corresponding vent 120. To further aid in directing the ejecta and hot gases most efficiently from the modules 150 to an exterior of the housing 110, the louvers 178 are open toward the corresponding vent 120.

In the present embodiment, the vents 120 are on a top side of the housing 110, with the louvers 178 opening upward toward the vents 120, as hot gases will rise inside the housing 110 in addition to the direction provided by the louvers 178. Depending on the particular arrangement of the battery pack 110 in a given vehicle, for instance, it is also contemplated that the directionality of the louvers 178 and vents 120 could vary. The top side cover 114 further includes channels 125 aligned with the vents 120 to aid in venting the ejecta and/or hot gases away from the vents 120. It is contemplated that the particular form of the vents 125 and the housing 110 could vary in different embodiments.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

What is claimed is:

1. A battery pack for an electric vehicle, the battery pack comprising:
a housing;
a first plurality of battery cells disposed inside the housing;
a second plurality of battery cells disposed inside the housing; and
a barrier disposed in the housing, the barrier being disposed between the first plurality of battery cells and the second plurality of battery cells,
the barrier comprising:
a first barrier plate facing the first plurality of battery cells, the first barrier plate having a first plurality of apertures defined therein,
the first barrier plate including a first plurality of louvers, each louver of the first plurality of louvers being formed around a portion of a corresponding aperture of the first plurality of apertures; and
a second barrier plate facing the second plurality of battery cells, the second barrier plate having a second plurality of apertures defined therein,
the second barrier plate including a second plurality of louvers, each louver of the second plurality of louvers being formed around a portion of a corresponding aperture of the second plurality of apertures,
each battery cell of the first plurality of battery cells and the second plurality of battery cells having a first end portion and a second end portion,
the first end portion of each battery cell of the first plurality of battery cells and the second plurality of battery cells being arranged closer to the barrier than the second end portion of each battery cell.

2. The battery pack of claim 1, wherein the first plurality of louvers and the second plurality of louvers are configured and arranged to direct ejecta from at least one battery cell of the first plurality of battery cells and the second plurality of battery cells toward the housing.

3. The battery pack of claim 1, wherein, for each battery cell of the first plurality of battery cells and the second plurality of battery cells, the battery cell comprises:
a battery casing extending from the first end portion to the second end portion; and
a venting valve at least partially disposed in the battery casing, the venting valve being disposed in the first end portion.

4. The battery pack of claim 3, wherein, for each battery cell of the first plurality of battery cells and the second plurality of battery cells, the venting valve is arranged to vent gases toward the barrier.

5. The battery pack of claim 1, wherein, for each battery cell of the first plurality of battery cells and the second plurality of battery cells:
the first end portion is at least partially aligned with a corresponding louver of the first and second plurality of louvers.

6. The battery pack of claim 1, wherein:
each louver of the first plurality of louvers defines a first opening between an edge of the louver and the first barrier plate, the first opening being fluidly connected with a corresponding aperture of the first plurality of apertures; and
each louver of the second plurality of louvers defines a second opening between an edge of the louver and the second barrier plate, the second opening being fluidly connected with a corresponding aperture of the second plurality of apertures.

7. The battery pack of claim 6, wherein:
a distance from the first barrier plate and a center of the edge of each louver of the first plurality of louvers is about 3 millimeters; and
a distance from the second barrier plate and a center of the edge of each louver of the second plurality of louvers is about 3 millimeters.

8. The battery pack of claim 1, wherein the first barrier plate and the second barrier plate are separated by about 10 millimeters.

9. The battery pack of claim 1, wherein the first plurality of louvers and the second plurality of louvers have a curved profile.

10. The battery pack of claim 1, wherein:
the housing defines therein at least one vent fluidly connecting an interior of the housing with an exterior of the housing;
the at least one vent is arranged in fluid communication with the barrier; and
the first plurality of louvers and the second plurality of louvers open toward the at least one vent.

11. The battery pack of claim 1, wherein:
the first plurality of battery cells is supported in a first frame;
the second plurality of battery cells is supported in a second frame;
the first barrier plate is connected to the first frame; and
the second barrier plate is connected in the second frame.

12. The battery pack of claim 11, wherein:
the first frame defines a first plurality of pockets, each battery cell of the first plurality of battery cells being received in a corresponding one of the first plurality of pockets; and
the second frame defines a second plurality of pockets, each battery cell of the second plurality of battery cells being received in a corresponding one of the second plurality of pockets.

13. A battery pack for an electric vehicle, the battery pack comprising:
a housing;
at least one plurality of battery cells disposed inside the housing; and
a barrier disposed in the housing,
the barrier comprising:
at least one barrier plate facing the at least one plurality of battery cells, the at least one barrier plate having a plurality of apertures defined therein,
the at least one barrier plate including a plurality of louvers, each louver of the plurality of louvers being formed around a portion of a corresponding aperture of the plurality of apertures,
each battery cell of the at least one plurality of battery cells having a first end portion and a second end portion,
the first end portion of each battery cell of the at least one plurality of battery cells being arranged closer to the barrier than the second end portion of each battery cell.

14. The battery pack of claim 13, wherein the plurality of louvers are configured and arranged to direct ejecta from at least one battery cell of the at least one plurality of battery cells toward the housing.

15. The battery pack of claim 13, wherein each battery cell comprises:
a battery casing extending from the first end portion to the second end portion;
a venting valve at least partially disposed in the battery casing, the venting valve being disposed in the first end portion; and
for each battery cell of the plurality of battery cells, the venting valve is arranged to vent gases toward the barrier.

16. The battery pack of claim 13, wherein, for each battery cell of the at least one plurality of battery cells:
the first end portion is at least partially aligned with a corresponding louver of the plurality of louvers.

17. The battery pack of claim 13, wherein each louver of the plurality of louvers defines an opening between an edge of the louver and the at least one barrier plate, the opening being fluidly connected with a corresponding aperture of the plurality of apertures.

18. The battery pack of claim 17, wherein a distance from the at least one barrier plate and a center of the edge of each louver of the plurality of louvers is about 3 millimeters.

19. The battery pack of claim 13, wherein each louver of the plurality of louvers has a curved profile.

20. The battery pack of claim 13, wherein:
the housing defines therein at least one vent fluidly connecting an interior of the housing with an exterior of the housing;
the at least one vent is arranged in fluid communication with the barrier; and
the plurality of louvers opens toward the at least one vent.
